(19) United States
(12) Patent Application Publication
(10) Pub. No.: US 2020/0111501 A1
(43) Pub. Date: Apr. 9, 2020

(54) AUDIO SIGNAL ENCODING METHOD AND DEVICE, AND AUDIO SIGNAL DECODING METHOD AND DEVICE

(71) Applicants: Electronics and Telecommunications Research Institute, Daejeon (KR); The Trustees of Indiana University, Indianapolis, IN (US)

(72) Inventors: Jongmo SUNG, Daejeon (KR); Seung Kwon BEACK, Daejeon (KR); Mi Suk LEE, Daejeon (KR); Tae Jin LEE, Daejeon (KR); Minje KIM, Bloomington, IN (US)

(73) Assignees: Electronics and Telecommunications Research Institute, Daejeon (KR); The Trustees of Indiana University, Indianapolis, IN (US)

(21) Appl. No.: 16/541,959

(22) Filed: Aug. 15, 2019

Related U.S. Application Data
(60) Provisional application No. 62/742,095, filed on Oct. 5, 2018.

(30) Foreign Application Priority Data
Feb. 15, 2019 (KR) 10-2019-0018134

(51) Int. Cl. G10L 19/038; G06N 3/08

(52) U.S. Cl. CPC G10L 19/038; G06N 3/088

(57) ABSTRACT

Disclosed are an audio signal encoding method and device, and an audio signal decoding method and device. The encoding method includes transforming an original test signal of a time domain being an audio signal into a frequency domain, binarizing a coefficient of the original test signal of the frequency domain, performing an encoding layer feedforward using the binarized coefficient and a training model parameter derived through a training process, and performing an entropy encoding based on a result of performing the encoding layer feedforward.

### CROSS-REFERENCE TO RELATED APPLICATION(S)

This application claims the priority benefit of U.S. Provisional Application No. 62/742,095 filed on Oct. 5, 2018 in the U.S. Patent and Trademark Office, and Korean Patent Application No. 10-2019-0018134 filed on Feb. 15, 2019 in the Korean Intellectual Property Office, the disclosures of which are incorporated herein by reference for all purposes.

### BACKGROUND

### 1. Field of the Invention

One or more example embodiments relate to an audio signal encoding method and device, and an audio signal decoding method and device and, more particularly, to an audio signal encoding method and device, and an audio signal decoding method and device using a binarization.

### 2. Description of the Related Art

Recently, with the development of deep learning technology, attempts to apply deep learning to various application fields have been made. One of the application fields is an audio field. An autoencoder, a type of neural network model, is used in relation to the deep learning technology. The autoencoder transforms high-dimensional input data into low-dimensional data, and restores the low dimensional representation back to the original high-dimensional input data. Here, a process of transforming high-dimensional input data into low-dimensional data corresponds to an encoding process, and a process of restoring the low-dimensional input data back to the high-dimensional input data corresponds to a decoding process.

A low-dimensional representation derived from the encoding process of the autoencoder is defined as a latent representation or code, and a layer outputting a code is referred to as a code layer. Model parameters of the autoencoder are obtained by minimizing errors between outputs and inputs of the autoencoder in a training process.

Neural networks are classified into a shallow neural network and a deep neural network (DNN) according to the number of hidden layers corresponding to the depth of the neural network. In this example, a latent representation obtained from the shallow neural network is imperfect. Thus, by performing training through additional hidden layers, the transformation process may be enhanced. An autoencoder using additional hidden layers is defined as a deep autoencoder.

However, the deep autoencoder needs to perform a test in a limited situation, and thus an operation time increases due to the hidden layers added to enhance the transformation process.

### SUMMARY

An aspect relates to deep autoencoding for audio signal encoding and audio signal decoding, and provides a method and device that may reduce an operation time through a binary neural network.

Another aspect relates to deep autoencoding for audio signal encoding and audio signal decoding, and provides a method and device that may reduce quantization noise caused by a binarization in a binary neural network.

According to an aspect, there is provided an encoding method including transforming a time-domain original test signal being an audio signal into a frequency domain, binarizing a coefficient of the frequency-domain original test signal, performing an encoding layer feedforward using the binarized coefficient and a training model parameter derived through a training process, and performing an entropy encoding based on a result of performing the encoding layer feedforward.

The training model parameter derived through the training process may be derived by redefining an operation and a model parameter of an autoencoder using a binary neural network in a bitwise manner.

The training model parameter derived through the training process may be derived based on a result of applying a bipolar binary input based on a weight of the model parameter to an XNOR operation.

The binary neural network may be a neural network in which an activation function is changed from a hyperbolic function to a sign function such that an output of a hidden unit is a bipolar binary number.

The binarizing may include reconstructing the coefficient of the frequency domain into a binary vector through a quantization and a dispersion process.

The performing of the entropy encoding may include performing the entropy encoding based on a probability distribution of a latent representation bitstream.

According to an aspect, there is provided a decoding method including outputting a latent representation bitstream from a bitstream through an entropy decoding, restoring a binary vector reconstructed through a decoding layer feedforward using the latent representation bitstream and a training model parameter derived through a training process, outputting a coefficient of a frequency domain by transforming the reconstructed binary vector into a real number by grouping the binary vector each by N bits, and transforming the coefficient of the frequency domain into a time domain.

The training model parameter derived through the training process may be derived by redefining an operation and a model parameter of an autoencoder using a binary neural network in a bitwise manner.

The training model parameter derived through the training process may be derived based on a result of applying a bipolar binary input based on a weight of the model parameter to an XNOR operation.

The binary neural network may be a neural network in which an activation function is changed from a hyperbolic function to a sign function such that an output of a hidden unit is a bipolar binary number.

According to an aspect, there is provided an encoding device including a processor configured to transform a time-domain original test signal being an audio signal into a frequency domain, binarize a coefficient of the frequency-domain original test signal, perform an encoding layer feedforward using the binarized coefficient and a training model parameter derived through a training process, and perform an entropy encoding based on a result of performing the encoding layer feedforward.

The training model parameter derived through the training process may be derived by redefining an operation and a model parameter of an autoencoder using a binary neural network in a bitwise manner.

The training model parameter derived through the training process may be derived based on a result of applying a bipolar binary input based on a weight of the model parameter to an XNOR operation.

The binary neural network may be a neural network in which an activation function is changed from a hyperbolic function to a sign function such that an output of a hidden unit is a bipolar binary number.

The processor may be configured to binarize the coefficient by reconstructing the coefficient of the frequency domain into a binary vector through a quantization and a dispersion process.

The processor may be configured to perform the entropy encoding based on a probability distribution of a latent representation bitstream.

According to an aspect, there is provided a decoding device configured to output a latent representation bitstream from a bitstream through an entropy decoding, restore a binary vector reconstructed through a decoding layer feedforward using the latent representation bitstream and a training model parameter derived through a training process, output a coefficient of a frequency domain by transforming the reconstructed binary vector into a real number by grouping the binary vector each by N bits, and transform the coefficient of the frequency domain into a time domain.

The training model parameter derived through the training process may be derived by redefining an operation and a model parameter of an autoencoder using a binary neural network in a bitwise manner.

The training model parameter derived through the training process may be derived based on a result of applying a bipolar binary input based on a weight of the model parameter to an XNOR operation.

The binary neural network may be a neural network in which an activation function is changed from a hyperbolic function to a sign function such that an output of a hidden unit is a bipolar binary number.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an audio signal encoding method and an audio signal decoding method according to an example embodiment;

FIG. 2 is a diagram illustrating an autoencoder according to an example embodiment;

FIG. 3 is a diagram illustrating a truth table of an XNOR operation according to an example embodiment;

FIG. 4 is a diagram illustrating a coefficient binarization method according to an example embodiment;

FIG. 5 is a diagram illustrating an example of a binary neural network (BNN) to solve an XOR problem with two hyperplanes according to an example embodiment;

FIG. 6 is a diagram illustrating an example of a problem linearly separable based on a BNN requiring two hyperplanes according to an example embodiment;

FIG. 7 is a diagram illustrating an example of a BNN allowing a weight of “0” to solve a linear separable problem according to an example embodiment; and

FIG. 8 is a diagram illustrating an example of a linearly separable problem that cannot be solved by a BNN with a single hyperplane according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

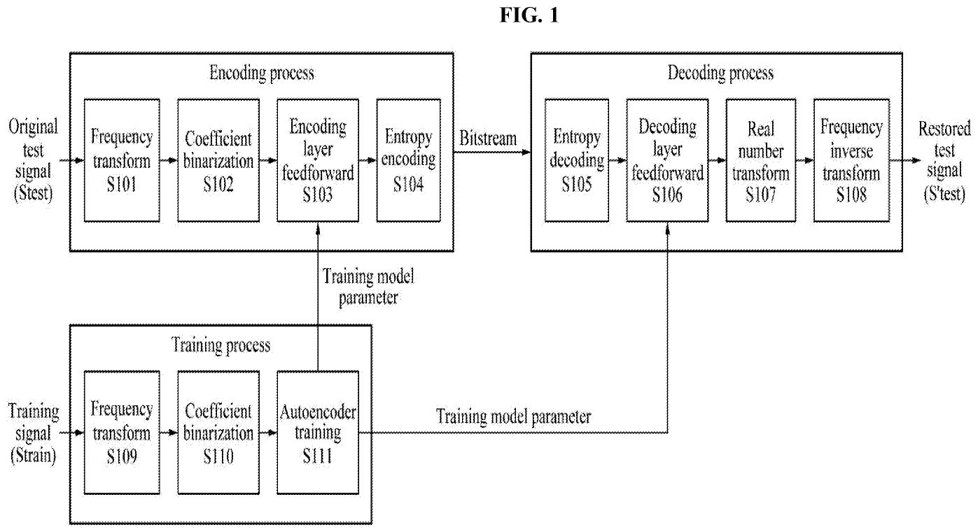

FIG. 1 is a diagram illustrating an audio signal encoding method and an audio signal decoding method according to an example embodiment.

Example embodiments provide a neural network training and testing method that may binarizing input data and model parameters such as a weight and a bias to be suitable for an XNOR logical operation using a binary neural network, and apply the binarized input data and model parameters to audio signal encoding and audio signal decoding based on an autoencoder. In particular, according to the example embodiments, since a separate table for speedup is not used, but XNOR logical operators are used, an additional memory for storing the table is unnecessary.

FIG. 1 illustrates a process of encoding an audio signal and decoding the audio signal using an autoencoder to which a binary operation is applied. Here, a process of encoding an original test signal and outputting a restored test signal by decoding the encoded original test signal corresponds to a testing process of FIG. 1. A process of training with a training signal corresponds to a training process of FIG. 1. Here, the original test signal, the restored test signal, and the training signal are all audio signals.

The encoding process, the decoding process, and the training process may be performed through different devices including a processor and a memory, or performed by the same device. The encoding process, the decoding process, and the training process may each be performed by the processor, and data input and output in each process may be stored in the memory.

A training process is required for an audio signal encoding process and an audio signal decoding process. In this example, a result derived through the training process is applied to the audio signal encoding process and the audio signal decoding process.

In FIG. 1, the encoding process corresponding to the testing process includes a frequency transform (S101), a coefficient binarization (S102), an encoding layer feedforward (S103), and an entropy encoding (S104). A result of encoding an original test signal being an audio signal, derived through the encoding process, is an input of the decoding process through a bitstream.

In particular, according to the example embodiments, a training process including a frequency transform (S109), a coefficient binarization (S110), and an autoencoder training (S111) is suggested. A process of training an autoencoder based on a binary operation refers to a process of training model parameters of a neural network using audio signals included in a big training database (DB). Here, the audio signals included in the training DB correspond to training signals Strain.

The frequency transform (S109) is a process of transforming an audio signal of a time domain included in the training DB into a frequency domain on a frame-by-frame basis using a transform algorithm such as short-time Fourier transform (STFT) or modified discrete cosine transform (MDCT), and outputting a coefficient of the frequency domain through this.

The coefficient binarization (S110) is a process of reconstructing the coefficient of the frequency domain derived through the frequency transform (S109) into a binary vector.

The autoencoder training (S111) refers to a process of training model training parameters of the autoencoder using the reconstructed binary vector. The autoencoder training (S111) is performed through a signal binarization, a weight compression, and, an error back propagation including quantization noise. A forward propagation is a process of applying a weight or a model parameter to values input through an input layer in a neural network, transferring the values to an output layer, and implementing a non-linear transform through an activation function in the process. On the contrary, a back propagation refers to a process of setting a difference between a result value of the forward propagation and a target value included in the training data as an error, and reupdating a weight to reduce the error. Through the back propagation, more errors may be fed back to a node (neuron) greatly affecting the result value.

However, when a training parameter has a discrete value or a binary value as suggested herein, it is difficult to differentiate an error function and perform an optimization using the same. To solve the foregoing, the error back propagation including quantization noise is suggested herein.

The training model parameters finally derived through the training process are applied to the encoding process and the decoding process.

The frequency transform (S101) and the coefficient binarization (S102) in the encoding process are performed in the same manner as in the frequency transform (S109) and the coefficient binarization (S110) in the training process.

The encoding layer feedforward (S103) outputs a latent representation bitstream using an encoding layer model parameter derived through the training process and the reconstructed binary vector being an output of the coefficient binarization (S102). Here, a latent representation is a low-dimension representation output in the encoding process of the autoencoder.

The entropy encoding (S104) performs an entropy encoding such as a Huffman coding or an arithmetic coding based on a probability distribution of the latent representation bitstream to further increase a compression rate. A bitstream is finally output through the encoding process.

When the Huffman coding is used in the entropy encoding (S104), a Huffman table formed in the training process may be used. In the training process, the Huffman table may be generated using a unique binary bit string set. However, when the number of audio signals included in the training DB is insufficient, the binary bit string generated in the encoding process being the testing process may not be found in the Huffman table generated in the training process. Thus, the entropy encoding (S104) needs to process, as an exception, a latent representation bit string not included in the Huffman table generated in the training process since the Huffman table for the entropy encoding (S104) may be incomplete depending on the configuration of the audio signals included in the training DB.

According to the example embodiments, a plurality of methods for processing the latent representation bit string not included in the Huffman table derived through the training process is provided.

The first method is preparing a Huffman table for bit strings corresponding to the number of all possible cases of audio signals included in the training DB, even if not included, when generating the Huffman table for a Huffman coding in the entropy encoding (S104).

The second method is, if a latent representation bit string not included appears in the training process, omitting a Huffman coding, and transmitting or storing the corresponding latent representation bit string as is.

The third method is, if a latent representation bit string not included in the Huffman table generated in the training process is verified, searching for another latent representation bit string corresponding to a Hamming distance closest to the latent representation bit string verified in the Huffman table, and then transmitting a codeword with respect to the found latent representation bit string instead.

The decoding process includes an entropy decoding (S105), a decoding layer feedforward (S106), a real number transform (S107), and a frequency inverse transform (S108).

In the entropy decoding (S105), a trainer of an audio codec using the bitwise autoencoder outputs a latent representation bitstream from the encoded bitstream being an output of an encoder through the entropy decoding process.

The decoding layer feedforward (S106) restores a reconstructed binary vector using a decoding layer model parameter trained by the trainer with the latent representation bitstream as an input.

The real number transform (S107) outputs a frequency domain coefficient restored by transforming the reconstructed binary vector into a real number by grouping the binary vector each by N bits.

The frequency inverse transform (S108) outputs a restored audio signal from the restored frequency domain coefficient using an inverse-transform algorithm.

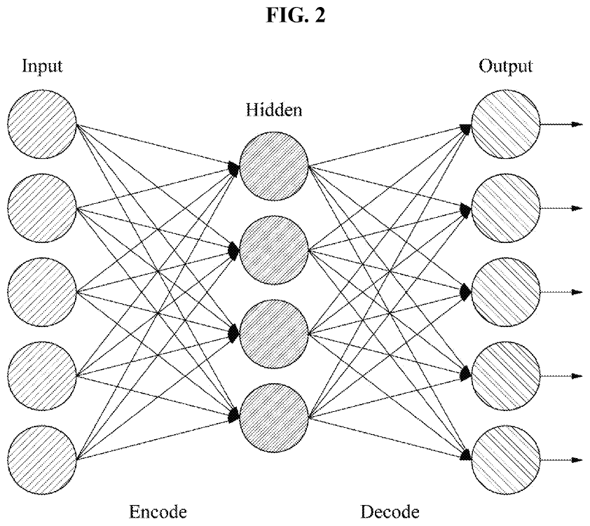

FIG. 2 is a diagram illustrating an autoencoder according to an example embodiment.

An autoencoding network may perform an encoding process moderately through dimension reduction. However, in order to utilize the autoencoding network as an effective encoding tool, a process of binarizing a latent representation or at least facilitating a binarization is essentially required. Semantic hashing may solve such an issue by forcing a code layer output to an extreme value by adding noise to an input of a code layer.

However, a semantic hashing network has a critical disadvantage of requiring excessive resources during a test time due to a large volume of parameters. Deep learning principally requires considerable effort such as great computational complexity for a training process, and requires relatively less computational complexity for a testing process.

However, to perform a test using a device having limited resources, there is still a burden in terms of time. In particular, in order to apply a deep neural network (DNN) to real-time application such as encoding and decoding, an excessive complexity of the DNN may be an obstacle, and thus the DNN may not be the best solution despite providing an excellent performance. For example, in a general neural network having 1024 hidden units for each layer, the number of addition and multiplication operations easily exceeds millions of floating point operations, and increases linearly as the depth of the network increases.

Herein, an autoencoder including an encoder and a decoder is used as an audio signal compression tool, and a code layer which is a predetermined hidden layer preferring to have a fewer number of hidden units is selected. With this regard, there are two significant issues to be solved herein.

First, since the encoder of the neural network performs a role for dimension reduction, a code layer should have as few hidden units as possible, and an artifact caused by dimension reduction should not be great in the decoder which performs a role for restoring a low-dimensionally represented code to an original signal.

Second, a quantization process such as a code binarization should be performed focusing on a distribution of the code layer output. That is, if it is possible to readily binarize the code layer output, the dimension of the code layer directly corresponds to the length of a code which is a bitstream representation of a compressed signal. As a method of quantizing the code layer, a sigmoid function, such as a logistic or hyperbolic tangent function, which provides a saturated output with respect to an input may be used.

However, since these methods do not produce highly saturated distributions, there has been suggested a semantic hashing method in which the distribution of the code layer output is very extreme by partially adding Gaussian noise to the input signal of the code layer.

In this example, the shape of the obtained distribution has two peaks concentrated around “0” and “1” in case of the logistic function, and a binarization operation simply delimits the values using a threshold of “0.5”. A layer including 32 units representing a deep-autoencoder with respect to semantic hashing may be used as the code layer.

Similar to the DNN, semantic hashing needs to perform several great matrix products in a feedforward operation and thus, has a limitation to hashing big data or converting signals in real time. There is still a burden in an environment with limited resources such as music playback on a mobile terminal and a real-time application.

In relation to a network compression for effectively improving a runtime, strong quantization technology such as a binarization which innovatively reduces the number of bits associated with data and model parameters is applied herein. An existing neural network operating with discrete parameters was used on hardware having a limited quantization level, which, however, results in a considerable degradation in the performance. Such issues may be moderately solved by performing a quantization in advance in the training operation in addition to final hardware implementation.

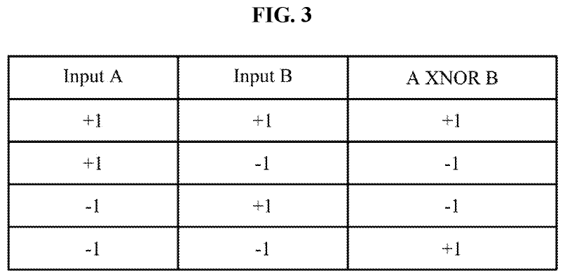

FIG. 3 is a diagram illustrating a truth table of an XNOR operation according to an example embodiment.

Herein, an extreme binarization method having three values of (+1, 0, −1) for all weights and signals to be suitable for a separate XNOR logical operation for speedup is adopted. Further, a training and test method for applying a speedup process to audio encoding is disclosed.

Herein, an operation and model parameters of the autoencoder for audio encoding and decoding may be redefined in a bitwise manner based on a binary neural network (BNN). For example, the model weight has a value of “+1” or “−1”, and a value of a result of multiplying a bipolar binary input by the weight is “1”. That is, a product of bipolar binary numbers is an XNOR gate operation. FIG. 3 shows a truth table of an XNOR operation.

The BNN changes an activation function from a hyperbolic tangent function tanh to a sign function such that an output of a hidden unit is a bipolar binary number. The sign function may also be calculated in a bitwise manner by comparing the number of “+1”s and the number of “−1”s. The feedforward process of the neural network may be performed much more simply using such a concept. For example, the memory may be reduced to 1/N when compared to a neural network in which weights have N-bit encoding.

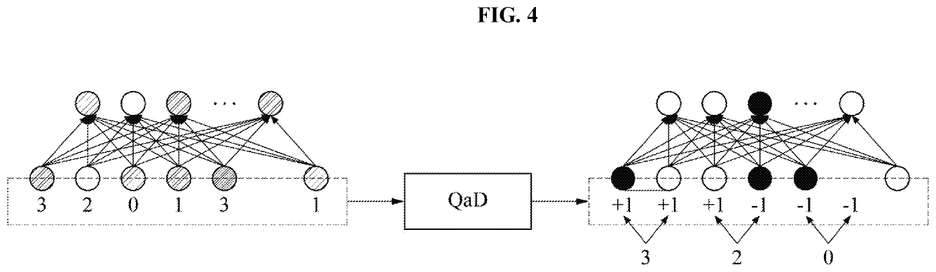

FIG. 4 is a diagram illustrating a coefficient binarization method according to an example embodiment.

Herein, an extreme binarization method having three values of (+1, 0, −1) for all weights and signals to be suitable for a separate XNOR logical operation for speedup is adopted. Further, a training and test method for applying a speedup process to audio encoding is disclosed.

A coefficient binarizer performs a preprocessing process of reconstructing a frequency domain coefficient appropriately into a binary vector, and Quantization-and-Dispersion (QaD) is used herein. In QaD, each real number term x_i of a D-dimensional input vector x∈R\hat{ }(D×1) is quantized by N bits using a Lloyd-Max algorithm so as to have 2\hat{ }N quantization levels, and then quantized integer values are distributed to N different input units such that they are one bit per unit with N-bit binary values. Through this distribution process, the number of units of an input layer increases from D to D×N.

FIG. 4 illustrates an example of a coefficient binarization method. For example, when a real number term is quantized by 2 bits, the real number term has an integer value of “3”, which is represented as a binary number of “11”. The respective bits of the binary number “11” are distributed as “+1” to two input units. If an integer value of “2” is quantized into a binary number “10”, bits thereof are distributed respectively as “+1” and “−1” to two input units.

Prior to applying a bitwise input reconstructed through the QaD operation directly to an actual bitwise autoencoder trainer, a process of compressing a weight and a bias being model parameters is performed. This process is to prevent staying at a local minimum in a training process by well setting the model parameters to be an initial value, rather than initializing the model parameters to a predetermined value. A real number network having the same neural network structure as that of a bitwise autoencoder to be trained is trained, and then a corresponding result is used as initial model parameters for training the bitwise autoencoder in practice.

In the model parameter compression process, the size of the input layer of the neural network is increased N times for an input bit string reconstructed through QaD. In the feedforward process, the model parameters are delimited to values between “−1” and “+1” by taking a tanh function for the weight and bias (W,b).

In a back propagation process for model parameter training, differential values of the tanh function, tanh′(W) and tanh′(b), need to be added further due to the model parameter compression. tanh(W) and tanh(b) obtained as a result of the model parameter compression are used as the initial model parameters of the bitwise autoencoder trainer.

A binary weight and a bias, W̅^{l}∈ [symbol] ^{K}^{^{l+1}}^{×K}^{^{l}}, b̅^{l}∈ [symbol] ^{K}^{^{l+1}}, with respect to an l-th layer of the bitwise autoencoder are binarized versions obtained by taking a sign function respectively for real number model parameters W^{l}∈ [symbol] ^{K}^{^{l+1}}^{×K}^{^{l}}, b^{l}∈ [symbol] ^{K}^{^{l+1}}, using a bipolar binary number [symbol] having K^{l} dimensions corresponding to the number of units of the l-th layer.

W̅^{l}←sign(W^{l})

b̅^{l}←sign(b^{l}) [Equation 1]

For noise back propagation, the binarized model parameters are used first to perform the feedforward process, as expressed by the following equation.

x^{l+1}←sign(W̅^{l}x^{l}+b̅^{l}=sign)sign(W^{l})x^{l}+sign(b^{l})) [Equation 2]

In Equation 2, x^{l} denotes an input of the l-th layer, which corresponds to an output or input layer (l=1) of an (l=1)-th hidden layer. However, the sign function cannot be differentialized near “0”. Thus, since the weight W and the bias b may not be updated in the back propagation process, differential values of the tanh function are used instead of differential values of the sign function.

Further, the model parameters binarized to further improve the performance in the training operation may be allowed to have values of “0”. In this example, the model parameter compression process may perform a binary quantization having quantization or inactivation weights of three levels, that is, −1, 0, and +1.

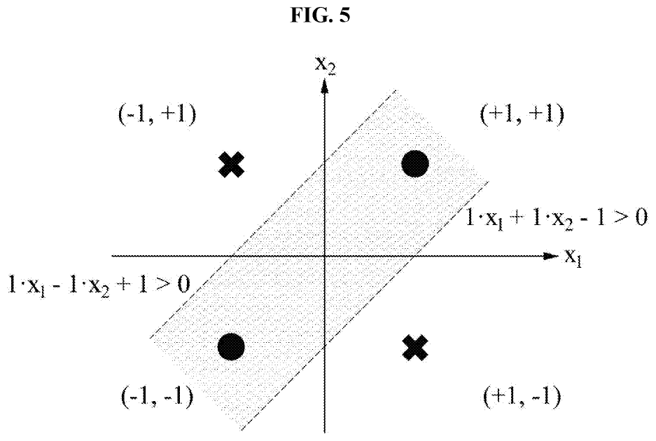

FIG. 5 is a diagram illustrating an example of a BNN to solve an XOR problem with two hyperplanes according to an example embodiment. An XOR problem is a linearly inseparable problem, and it is shown that the BNN may solve the non-linear problem by training suitable two hyperplanes.

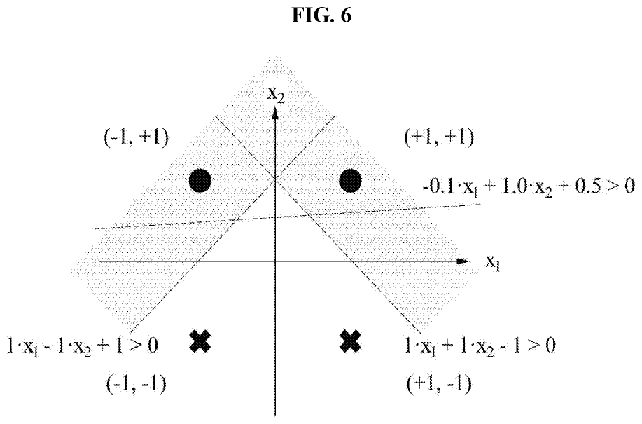

On the contrary, FIG. 6 is a diagram illustrating an example of a problem linearly separable based on a BNN requiring two hyperplanes according to an example embodiment. A problem of FIG. 6 is linearly separable, and thus a general real number-based neural network may solve the problem with only a single hyperplane (for example, x₂=0). However, since the BNN has a limited hyperplane that may be defined, at least two hyperplanes should be necessarily used to solve this problem. Thus, FIG. 6 implies that the model complexity of the BNN may be greater than that of a general neural network.

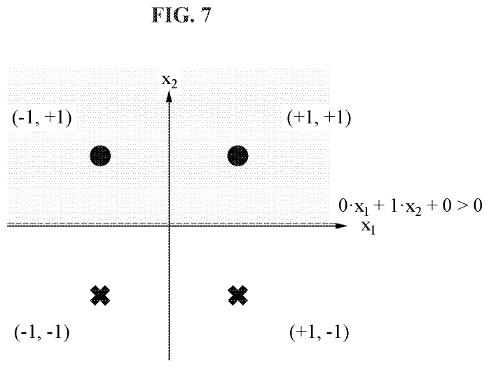

FIG. 7 is a diagram illustrating an example of a BNN allowing a weight of “0” to solve a linear separable problem according to an example embodiment. When “0” is used in addition to the bipolar binary numbers “+1” and “−1”, hyperplanes that may be defined by the BNN may become more flexible. In addition, by allowing a weigh of “0”, a problem may be solved with a single hyperplane.

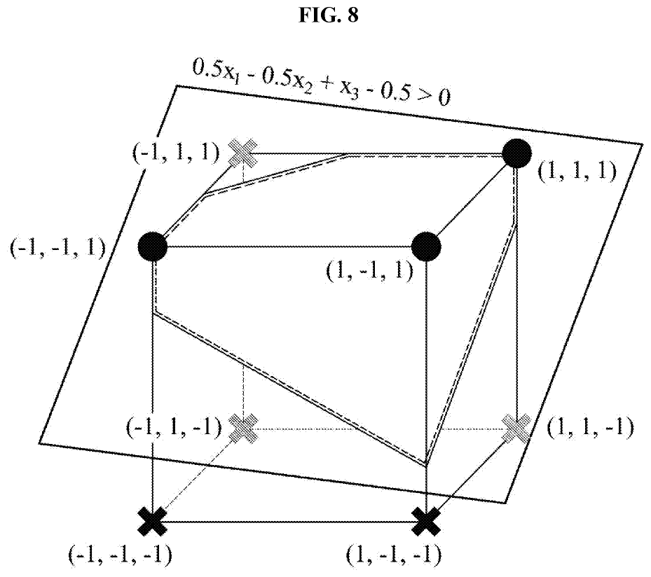

FIG. 8 is a diagram illustrating an example of a linearly separable problem that cannot be solved by a BNN with a single hyperplane according to an example embodiment. FIG. 8 illustrates a problem that may not be linearly separated by the BNN even when the weight of “0” is used additionally. The example of FIG. 8 shows an example of the BNN requiring an additional model complexity, when compared to a general neural network, through the fact that the general neural network is still capable of linear separation. However, the model complexity mentioned above is based on the number of neurons of the neural network, and does not indicate an actual computational complexity that the respective neurons and weight have an influence on the forward propagation process on hardware. The BNN may efficiently perform a forward propagation through binary representations. Thus, a BNN having more neurons may perform the forward propagation more efficiently than a BNN having fewer neurons.

A BNN was suggested first as a complete bitwise neural network such that bipolar binary parameters have a capability to solve a non-linear problem such as XOR of FIG. 5. However, the BNN requires more hyperplanes than a network generally having a real value.

For example, when linear separation is possible as shown in FIG. 6, there are two hyperplanes. In this example, the problem may be solved by allowing the weight to have a value of “0” as shown in FIG. 7. However, there exists a special case in which linear separation is impossible using a bitwise weight although the weight of “0” is allowed (FIG. 8). However, it does not indicate that the BNN requires a greater computational complexity than a DNN at all times for solving the same problem since the BNN has a much simpler arithmetic operation set.

When a network binarization is performed by the BNN even in a training operation, a stochastic gradient descent (SGD) method may reduce original training errors and additional errors caused by signals and binarized weights.

According to example embodiments, it is possible to improve a complexity and an operation time while providing the same quality as that of the existing scheme, through a method of binarizing model parameters and input signals.

According to example embodiments, it is possible to provide an audio codec capable of fast processing while maintaining a predetermined level of quality even in a mobile terminal having relatively less resources.

The components described in the example embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The units described herein may be implemented using a hardware component, a software component and/or a combination thereof. A processing device may be implemented using one or more general-purpose or special purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. An encoding method, comprising:
transforming a time-domain original test signal being an audio signal into a frequency domain;
binarizing a coefficient of the frequency-domain original test signal;
performing an encoding layer feedforward using the binarized coefficient and a training model parameter derived through a training process; and
performing an entropy encoding based on a result of performing the encoding layer feedforward.

2. The encoding method of claim 1, wherein the training model parameter derived through the training process is derived by redefining an operation and a model parameter of an autoencoder using a binary neural network in a bitwise manner.

3. The encoding method of claim 1, wherein the training model parameter derived through the training process is derived based on a result of applying a bipolar binary input based on a weight of the model parameter to an XNOR operation.

4. The encoding method of claim 2, wherein the binary neural network is a neural network in which an activation function is changed from a hyperbolic function to a sign function such that an output of a hidden unit is a bipolar binary number.

5. The encoding method of claim 1, wherein the binarizing comprises reconstructing the coefficient of the frequency domain into a binary vector through a quantization and a dispersion process.

6. The encoding method of claim 1, wherein the performing of the entropy encoding comprises performing the entropy encoding based on a probability distribution of a latent representation bitstream.

7. A decoding method, comprising:
outputting a latent representation bitstream from a bitstream through an entropy decoding;
restoring a binary vector reconstructed through a decoding layer feedforward using the latent representation bitstream and a training model parameter derived through a training process;
outputting a coefficient of a frequency domain by transforming the reconstructed binary vector into a real number by grouping the binary vector each by N bits; and
transforming the coefficient of the frequency domain into a time domain.

8. The decoding method of claim 7, wherein the training model parameter derived through the training process is derived by redefining an operation and a model parameter of an autoencoder using a binary neural network in a bitwise manner.

9. The decoding method of claim 7, wherein the training model parameter derived through the training process is derived based on a result of applying a bipolar binary input based on a weight of the model parameter to an XNOR operation.

10. The decoding method of claim 8, wherein the binary neural network is a neural network in which an activation function is changed from a hyperbolic function to a sign function such that an output of a hidden unit is a bipolar binary number.

11. An encoding device, comprising:
a processor configured to transform a time-domain original test signal being an audio signal into a frequency domain, binarize a coefficient of the frequency-domain original test signal, perform an encoding layer feedforward using the binarized coefficient and a training model parameter derived through a training process, and perform an entropy encoding based on a result of performing the encoding layer feedforward.

12. The encoding device of claim 11, wherein the training model parameter derived through the training process is derived by redefining an operation and a model parameter of an autoencoder using a binary neural network in a bitwise manner.

13. The encoding device of claim 11, wherein the training model parameter derived through the training process is derived based on a result of applying a bipolar binary input based on a weight of the model parameter to an XNOR operation.

14. The encoding device of claim 12, wherein the binary neural network is a neural network in which an activation function is changed from a hyperbolic function to a sign function such that an output of a hidden unit is a bipolar binary number.

15. The encoding device of claim 11, wherein the processor is configured to binarize the coefficient by reconstructing the coefficient of the frequency domain into a binary vector through a quantization and a dispersion process.

16. The encoding device of claim 11, wherein the processor is configured to perform the entropy encoding based on a probability distribution of a latent representation bitstream.

17. A decoding device, configured to output a latent representation bitstream from a bitstream through an entropy decoding, restore a binary vector reconstructed through a decoding layer feedforward using the latent representation bitstream and a training model parameter derived through a training process, output a coefficient of a frequency domain by transforming the reconstructed binary vector into a real number by grouping the binary vector each by N bits, and transform the coefficient of the frequency domain into a time domain.

18. The decoding device of claim 17, wherein the training model parameter derived through the training process is derived by redefining an operation and a model parameter of an autoencoder using a binary neural network in a bitwise manner.

19. The decoding device of claim 17, wherein the training model parameter derived through the training process is derived based on a result of applying a bipolar binary input based on a weight of the model parameter to an XNOR operation.

20. The decoding device of claim 18, wherein the binary neural network is a neural network in which an activation function is changed from a hyperbolic function to a sign function such that an output of a hidden unit is a bipolar binary number.
